(19) United States
(12) Patent Application Publication
(10) Pub. No.: US 2026/0014925 A1
(43) Pub. Date: Jan. 15, 2026

(54) Fast-Connecting Safety Tensioning Device for Automobiles

(71) Applicant: Ningbo Xuli Metal Products Co., Ltd., Ningbo (CN)

(72) Inventors: Weiguo Chen, Ningbo (CN); Yanqiong Chen, Ningbo (CN); Kefeng Jin, Ningbo (CN); Wei Deng, Ningbo (CN); Haitao Liu, Ningbo (CN)

(21) Appl. No.: 18/814,889

(22) Filed: Aug. 26, 2024

(30) Foreign Application Priority Data
Jul. 12, 2024 (CN) 202421655551.7

(51) Int. Cl. B60P 7/08

(52) U.S. Cl. CPC B60P 7/083

(57) ABSTRACT

A fast-connecting safety tensioning device for automobiles comprises a main body which consists of a base assembly, a handle assembly and a rolling assembly; and a band. The base assembly comprises a base, the rolling assembly comprises a spindle for mounting the band, the spindle is mounted on the base. The base has one or more threaded holes on a bottom of the base for one or more screws to pass through so as to quickly mount the fast-connecting safety tensioning device onto an object to be fixed in place (for example, a sidewall B of the pickup truck, the trailer trestle A, the car deck, etc.). One or more rivet nuts each having one threaded hole are integrally formed on the bottom of the base. The connection stability and the bearing capacity are greatly improved. Technical problems of the existing tensioning device can be effectively solved.

### TECHNICAL FIELD OF THE INVENTION

The present invention relates to a safety tensioning device for automobiles which is used for fixing and fastening cargos on vehicles such as automobiles, trailers, airplanes and ships, and in particular to a safety tensioning device for automobiles which can be quickly connected to corresponding positions of vehicles such as automobiles, pickup trucks and trailers.

### BACKGROUND OF THE INVENTION

A safety tensioning device for automobiles usually comprises a main body of the tensioning device, a long band, a short band, etc. Each band is usually a flat webbing, with or without a hook. The main body of the safety tensioning device is designed on the basis of a working prince of an irreversible ratchet mechanism. The driving pawl is directly driven by the handle, the ratchet wheel is pushed by the driving pawl, and the main rotating shaft is directly driven by the ratchet wheel. In this way, the band on the main rotating shaft is tensioned. The brake plate prevents a reversible rotation of the ratchet wheel, so that the band is kept in some tension, and cargos are thus held and fixed. For different application scenarios, a working length the band of the device is different. Accordingly, there are always excess bands left outside the device, resulting in certain potential safety hazard. Furthermore, it is inconvenient to use next time since the bands are in a mess after use.

At present, some products with bands capable of being rolled up automatically are sold in a market. Such a product has a ratchet reel. The bands are rolled up automatically by energy stored by using a volute spiral spring. Thus, the above-stated problem of the safety tensioning device for automobiles is solved. While in some special application scenarios, for example, when the safety tensioning device with bands capable of being rolled up automatically is connected to inner sidewalls of pickup trailers or on trailer trestles by a plurality of bolts (in this case, no short band is needed), the safety tensioning device can be used repeatedly and may not be taken down every time. It is thus convenient to use. However, in a connection process of the present safety tensioning device, a pair of screw and nut is additionally needed. The screw goes, from an inside of a base of the tensioning device, through a hole formed on the base and an object to be fixed in place, and is then locked by the nut. Due to a limited space inside the tensioning device, inconvenience caused by going in and out of the screws, and difficulty generated in tightening of the screws by general tools, it is difficult to operate and low in mounting efficiency, resulting in both time and effort waste. Meanwhile, by using such a connection method, only one end of the tensioning device is fixed. As a result, it is low in stability and also low in bearing capacity, particularly in some special stress angels.

In conclusion, it is necessary to further improve the existing safety tensioning device for automobiles.

### SUMMARY OF THE INVENTION

It is an object of the present invention to provide a fast-connecting safety tensioning device for automobiles, which is quite convenient for quick connection and operation, good in stability and high in bearing capacity.

For achieving the above object, the fast-connecting safety tensioning device for automobiles comprises a main body which consists of a base assembly, a handle assembly and a rolling assembly; and a band; wherein, the base assembly comprises a base having a bottom, the rolling assembly comprises a spindle for mounting the band, the spindle is mounted on the base; the base has one or more threaded holes on the bottom of the base for one or more screws to pass through so as to mount the fast-connecting safety tensioning device onto an object to be fixed in place.

The threaded holes can be designed in various ways. Preferably, one or more rivet nuts each having one threaded hole are integrally formed on the bottom of the base.

To improve the stability for connection, preferably, the number of the threaded holes is two and the two threaded holes are respectively located on opposite sides of the spindle.

Since the base of the safety tensioning device is usually a thin plate, two blind rivet nuts each having one threaded hole are disposed on the bottom of the base, which is convenient for manufacturing and ensures a connection firmness.

Preferably, a first threaded nut with a first threaded hole and a second threaded nut with a second threaded hole are disposed on the bottom of the base; the first threaded nut is adjacent to the band and extends downward from the bottom of the base, the second threaded nut extends upward from the bottom of the base. Under such a design, the first threaded hole is prevented from resisting against the band mounting on the spindle, ensuring a mounting reliability of the safety tensioning device. Of course, the arrangement and design of two threaded nuts are not limited in such a way, and corresponding changes may be made according to different application scenarios.

In order to increase the connection effect of the threaded holes, preferably, the one or more threaded holes comprise a first threaded hole and a second threaded hole; a first column with the first threaded hole extends downward from the bottom of the base, and a second column with the second threaded hole extends upward from the bottom of the base. Under the design of the two columns each having an inner threaded hole, the height of the threaded hole is increased compared with the manner that the threaded hole directly formed on the bottom of the base.

Preferably, a connecting plate having one or more connecting holes for allowing the one or more screws to pass through is disposed under the bottom of the base, so that the main body is mounted onto an object to be fixed in place. Under such a design, when it is inconvenient for screws to pass through some objects to be fixed in place (for example, an outer sidewall of a pickup truck), a connection of the safety tensioning device can be ensured.

Compared with the prior art, the safety tensioning device for automobiles of present invention has the following advantages: since the base has one or more threaded holes on the bottom of the base, the safety tensioning device can be quickly connected to corresponding positions of vehicles such as automobiles, pickup trucks and trailers by the one or more screws. Additionally, it is unnecessary to take the safety tensioning device down since the band can be rolled up into the main body at the end of use. It is convenient and quick in use, and also safe and reliable. Since the two threaded holes are respectively located on opposite sides of the spindle for connection, the connection stability and the bearing capacity are greatly improved. Thus, with the use of the safety tensioning device of the present invention, technical problems of the existing tensioning device, i.e., difficulty in operating screws and nuts due to limited inside space, low mounting efficiency and low stability, can be effectively solved.

### BRIEF DESCRIPTION OF THE DRAWINGS

FIG. 1 is an exploded view of a fast-connecting safety tensioning device for automobiles according to Embodiment 1 of the present invention;

FIG. 2 is a perspective view of the fast-connecting safety tensioning device according to Embodiment 1 of the present invention;

FIG. 3 is a front view of the fast-connecting safety tensioning device according to Embodiment 1 of the present invention;

FIG. 4 is a sectional view of a base with two threaded nuts according to Embodiment 1 of the present invention;

FIG. 5 is a perspective view of a main body of the present invention showing how the main body is connected to a trestle/side plate of a trailer;

FIG. 6 is an exploded view of the main body and the connecting plate of the present invention showing how the main body is connected to a connecting plate;

FIG. 7 is a sectional view of the main body and the connecting plate of the present invention when the main body is connected to the connecting plate;

FIG. 8 is an exploded view of the main body and an inner sidewall of a pickup truck of the present invention showing how the main body is connected to the inner sidewall of the pickup truck through the connecting plate;

FIG. 9 is a sectional view of a base according to Embodiment 2 of the present invention.

The reference numbers and the corresponding names of components are listed as below: 1: main body; 11: base assembly; 111: base; 112: brake plate; 113: brake plate spring; 114: support plate; 115: press plate; 116: press plate spring; 117: housing; 12: handle assembly; 121: handle; 122: driving pawl; 123: pawl spring; 13: rolling assembly; 131: spindle; 132: sleeve; 133: reel; 134: coil spring; 135: coil spring holder; 136: ratchet wheel; 137: drum; 138: retainer spring; 2: band; 21: webbing; 22: hook; 3: blind rivet nut; 3a: first threaded nut; 3b: second threaded nut; 31: threaded hole; 31a: first threaded hole; 31b: second threaded hole; 4: screw; 4a: first mounting screw; 4b: second mounting screw; 4′: screw; 5: connecting plate; 51: mounting hole; 51a: first mounting hole; 51b: second mounting hole; 51′: connecting hole; 3a′: first column; 3b′: second column; A: trailer trestle; and B: sidewall of the pickup truck.

### DETAILED DESCRIPTION OF THE INVENTION

The present invention will be further described below in detail by an embodiment with reference to the accompanying drawings.

### Embodiment 1

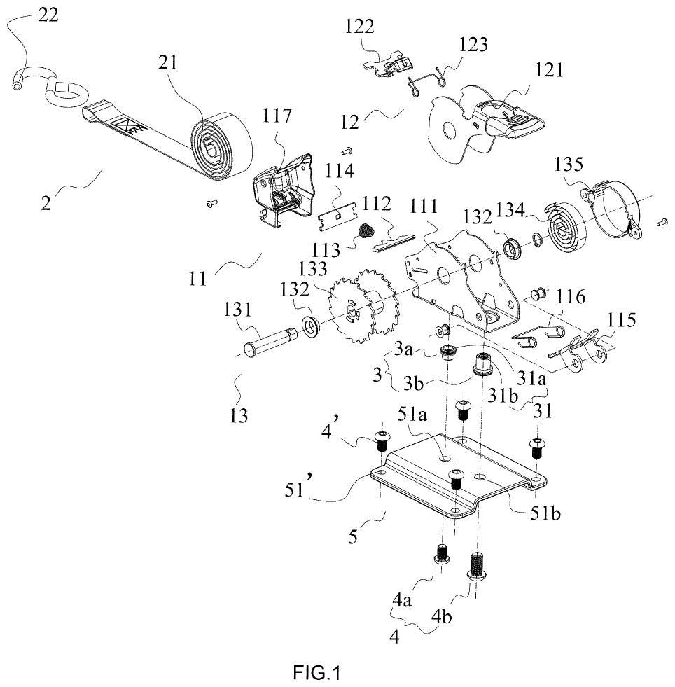

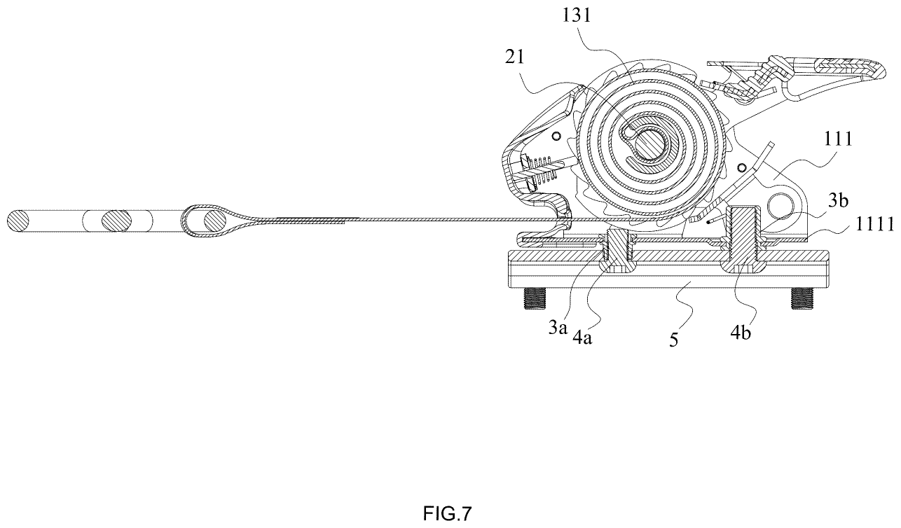

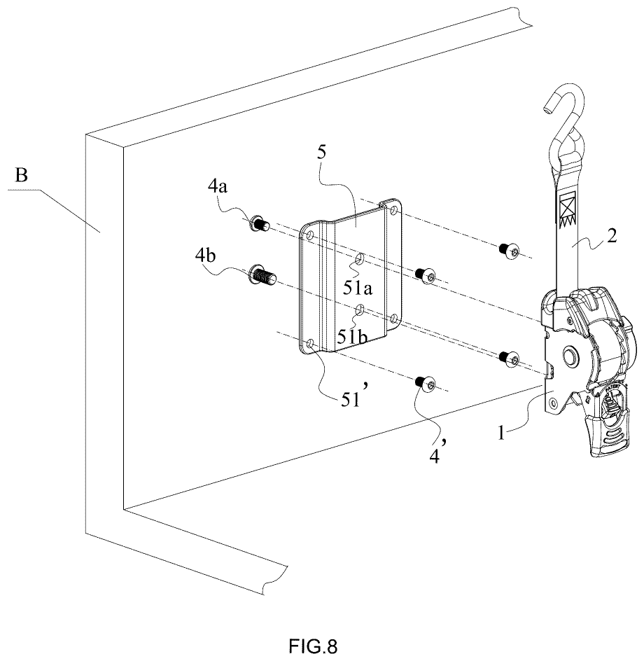

FIGS. 1-8 show a first preferred embodiment (Embodiment 1) of a fast-connecting safety tensioning device for automobiles of the present invention. The fast-connecting safety tensioning device for automobiles in this embodiment comprises a main body 1, a band 2 with a hook 22, and a connecting plate 5.

The main body 1 may uses a conventional structure. As shown in FIG. 1 of this embodiment, the main body 1 mainly comprises a base assembly 11, a handle assembly 12 and a rolling assembly 13. The base assembly 11 comprises a base 111 having a front end and a rear end. A housing 117 is connected to the front end of the base 111, a support plate 114, a brake plate 112 and a brake plate spring 113 are disposed inside the housing 117 at the front end of the base 111, and a press plate 115 and a press plate spring 116 are disposed at the rear end of the base 111.

The handle assembly 12 comprises a handle 121, a driving pawl 122 and a pawl spring 123, the driving pawl 122 and the pawl spring 123 are disposed on the handle 121. The handle 121 is pivoted to the base 111 and is capable of rotating around the spindle 131. Furthermore, the handle 121 can be rotated to change a state of the brake plate 112 and the press plate 115 acting on a ratchet wheel 136. The driving pawl 122 is rotatably connected onto the handle 121.

The rolling assembly 13 comprises a reel 133, a spindle 131, a sleeve 132, a coil spring 134 and a coil spring holder 135. The disk-shaped reel 133 consists of two opposite ratchet wheels 136 and a drum 137 connected between the two ratchet wheels 136, and is used for winding a webbing 21 of the band 2. The ratchet wheel 136 is prevented from reversible rotation by the brake plate 112 and a rotation speed of the ratchet wheel 136 is controlled by the press plate 115.

The handle 121 is disposed inside the base 111, and the reel 133 is centered inside the handle 121. The spindle 131 passes through the sleeve 132 and the reel 133, and is limited by a retainer spring 138. The spindle 131 has a specially-shaped cross section matched with a specially-shaped hole formed on a surface of each ratchet wheel 136, so that the reel 133 is capable of driving the spindle 131 to rotate together, or so that the spindle 131 is capable of driving the reel 133 to rotate together. The coil spring 134 comprises an inner hook and an outer hook, and an end of the spindle 131 adjacent to the coil spring holder 135 is connected to the inner hook of the coil spring 134. The outer hook of the coil spring 134 is connected to the coil spring holder 135 which is connected to a sidewall of the base 111. With an arrangement of the coil spring 134 and the coil spring holder 135, the band 2 of the safety tensioning device can be rolled up automatically. It requires no manual operation since the band 2 can be rolled up into the main body 1 automatically at the end of use. Thus, it is quite convenient to use.

The band 2 is mounted on the spindle 131 and can be wound onto the reel 133.

The above structure has applied in the existing safety tensioning device, and will not be repeated here. Of course, a structure of the main body 1 is not limited in such a way. Other similar conventional structures or modified structures may be applied to the main body 1.

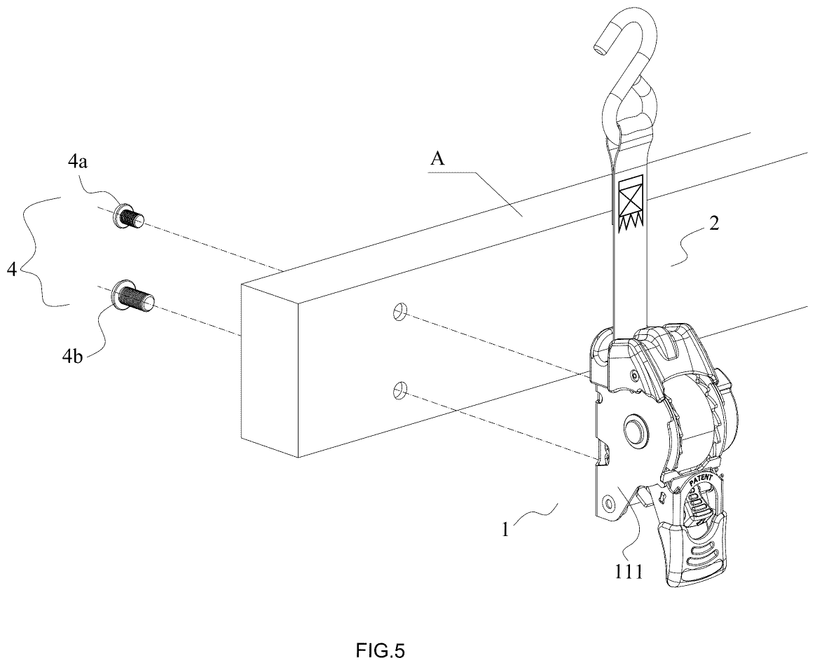

The difference of the safety tensioning device of the present invention is an improved base 111. That is, the base 111 has at least one threaded holes 31 on a bottom 1111 of the base 111. To improve a connection stability of the safety tensioning device, two threaded holes 31 are preferred, which are respectively located on opposite sides of the spindle 131. As shown in Figures, two threaded holes 31 comprise a first threaded hole 31a and a second threaded hole 31b. Since the main body 1 of the safety tensioning device has two threaded holes 31 for connection, each screw 4 is just screwed into a corresponding threaded hole 31 when the safety tensioning device should be connected to an object (as shown in FIG. 5), so that convenient and quick mounting process, high stability and high bearing capacity can be ensured.

The threaded holes 31 can be designed in various ways. For example, in a first way, threads are directly tapped on the bottom 1111 of the base 111 to form two threaded holes 31. However, since the base 111 is a thin plate (also due to a limitation of materials of the base 111, the safety tensioning device in the prior art is always mounted by a conventional technical method: the base has one or more mounting holes without threads formed on a bottom surface of the base for one or more screws to pass through, and each screw passes through the corresponding mounting hole to be screwed with corresponding nut for connection, instead of thinking that the safety tensioning device can be mounted by one or more screws being screwed into one or more threaded holes formed on the bottom of the base), few threads can be tapped, and the height of each threaded hole is just the thickness of the bottom 1111 of the base 111, which leads to low connection strength. In a second way, two threaded nuts each having a threaded hole are welded on the bottom 1111 of the base 111 by different welding methods (for example, gas shielded welding, argon arc welding, electric resistance welding, etc.). In a third way, two threaded nuts each having a threaded hole are riveted on the bottom 1111 of the base 111. Also, the mounting manner of the threaded nuts can be various, for example, ring-cut riveting, flange riveting, using a blind rivet nut, etc., all of which belong to a mounting manner of rivet nuts.

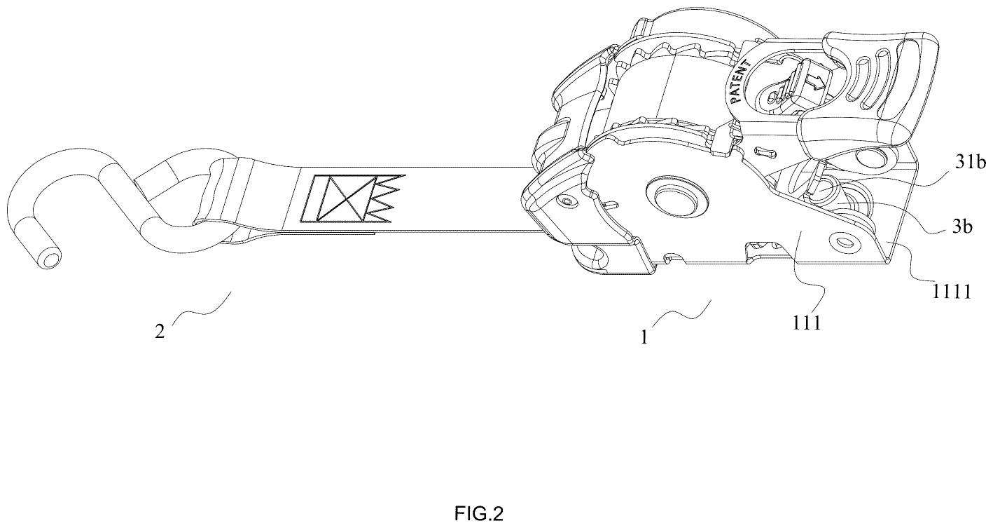

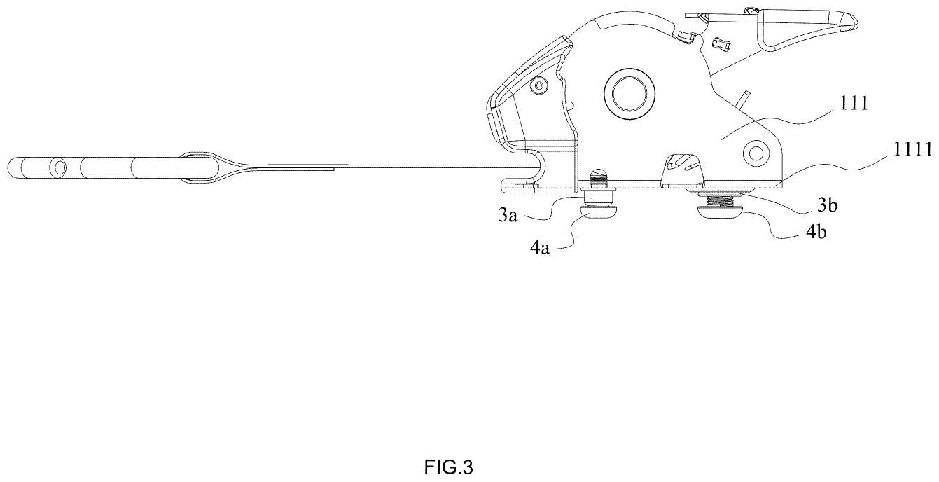

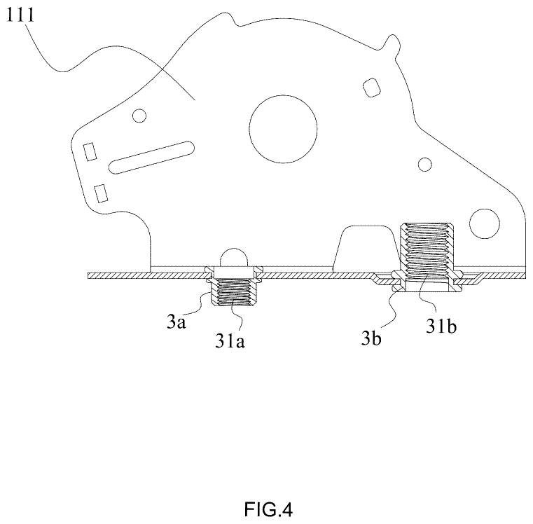

In the embodiment, two rivet nuts, preferably two blind rivet nuts 3 comprising a first threaded nut 3a and a second threaded nut 3b, each having one threaded hole 31 are disposed on the bottom 1111 of the base 111. As shown in FIG. 3 and FIG. 4, the first threaded nut 3a with the first threaded hole 31a and the second threaded nut 3b with the second threaded hole 31b are integrally disposed on the bottom 1111 of the base 111 and are respectively located on opposite sides of the spindle 131 along the radial direction of the spindle 131. As shown in FIG. 3 and FIG. 4, the first threaded nut 3a is adjacent to the band 2 and extends downward from the bottom 1111 of the base 111, so that the screw in the first threaded hole 31a is prevented from touching with the webbing 21 of the band 2 mounting on the spindle 131. The second threaded nut 3b extends upward from the bottom 1111 of the base 111 as shown in FIG. 2 and FIG. 4. The first threaded nut 3a and the second threaded nut 3b are respectively located on opposite sides of the spindle 131. Of course, an arrangement and design of two threaded holes 31a and 31b is not limited in such a way, and corresponding changes may be made according to different applications. For example, the second threaded nut (the second threaded hole 31b) may extend downward from the bottom 1111 of the base 111, with a same quick-connection effect.

For the fast-connecting safety tensioning device for automobiles, since the device has the first threaded nut 3a with the first threaded hole 31a and the second threaded nut 3b with the second threaded hole 31b disposed on the bottom 1111 of the base 111, two screws 4 (including the first mounting screw 4a and the second mounting screw 4b) pass through the corresponding threaded holes 31 on the base 111 of the main body 1 (as shown in FIG. 3), so that the safety tensioning device can be mounted onto an object to be fixed in place (as shown in FIG. 5), for example, a sidewall B of the pickup truck, the trailer trestle A, the car deck, etc.

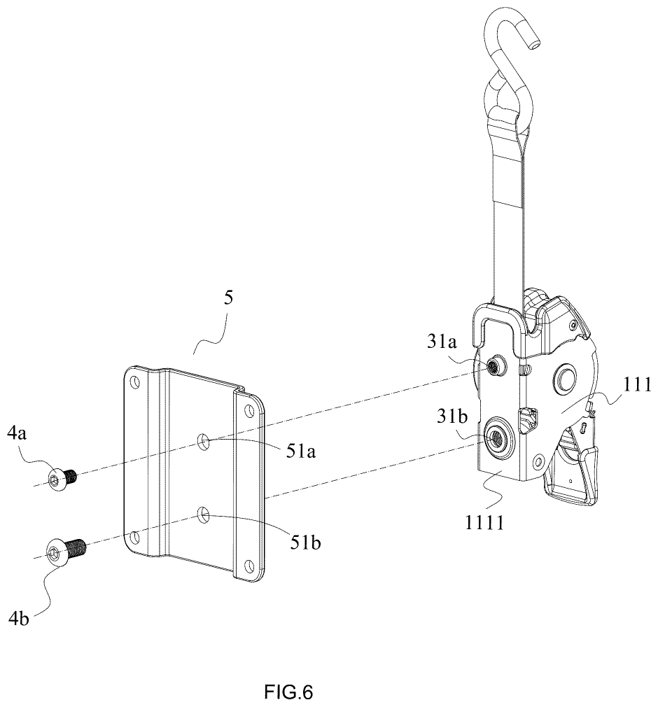

For the fast-connecting safety tensioning device for automobiles, the main body 1 may be connected to an object to be fixed in place by a connecting plate 5 (as shown in FIGS. 6-8) in addition to being directly connected to the above object by the screws 4 (as shown in FIG. 5). It is particularly suitable for objects which is inconvenient to pass the screws from the outside, for example, pickup trucks. In order to pass the screws 4, the connecting plate 5 has two mounting holes 51 (including the first mounting hole 51a and the second mounting hole 51b) corresponding to the two threaded holes 31 on the base 111, and a plurality of connecting holes 51′ used for the connecting plate 5 being mounted on the pickup truck. When in use, firstly the connecting plate 5 is connected to the main body 1 by the first mounting screw 4a and the second mounting screw 4b each passing through the corresponding mounting hole 51, and then the main body 1 and the connecting plate 5 are mounted onto the pickup truck by a plurality of screws 4′.

### Embodiment 2

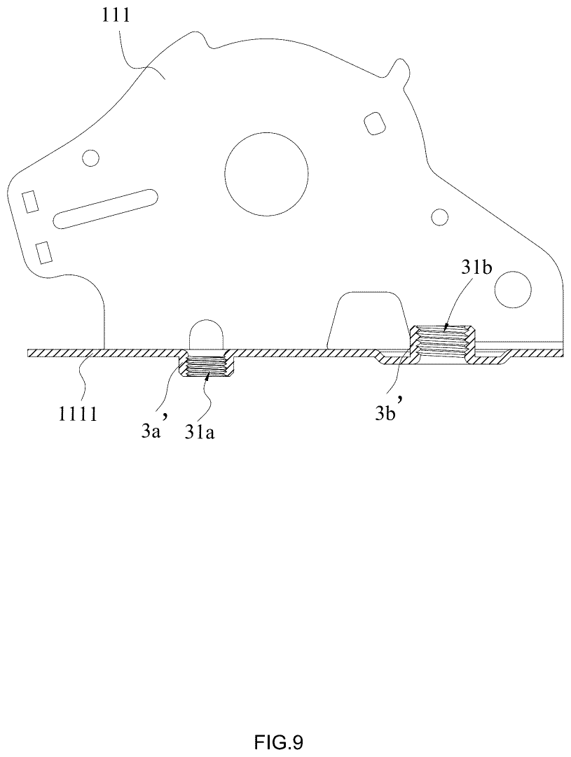

FIG. 9 is a sectional view of a base 111 of a fast-connecting safety tensioning device for automobiles according to Embodiment 2 of the present invention. The fast-connecting safety tensioning device in this embodiment differs from that in Embodiment 1 the design of the one or more threaded holes 31 on the base 111. Specifically, the one or more threaded holes 31 comprise a first threaded hole 31a and a second threaded hole 31b which are respectively located on opposite sides of the spindle 131;
a first column 3a′ with the first threaded hole 31a extends downward from a bottom 1111 of the base 111, and a second column 3b′ with the second threaded hole 31b extends upward from the bottom 1111 of the base 111.

During a manufacturing process, the bottom 1111 of the base 111 is flanged downward to form a protruding column extending downward at a corresponding position on the bottom 1111 of the base 111, and flanged upward to form a protruding column extending upward at a corresponding position on the bottom 1111 of the base 111, then, tapping each protruding column to form an internal thread which is respectively defined as the first threaded hole 31a and the second threaded hole 31b.

Compared with a simple method to directly tap the bottom 1111 of the base 111 to form the first threaded hole 31a and the second threaded hole 31b, in this embodiment, the two height of each column 3a′, 3b′ formed by hole flanging is greater than a thickness of the bottom 111, so that the connection effect of the threaded holes 31 can be increased, a connection between the safety tensioning device for automobiles and an object to be mounted on is firmer and more reliable.

1. A fast-connecting safety tensioning device for automobiles, comprising:
a main body (1) which consists of a base assembly (11), a handle assembly (12) and a rolling assembly (13); and
a band (2);
wherein,
the base assembly (11) comprises a base (111) having a bottom (1111), the rolling assembly (13) comprises a spindle (131) for mounting the band (2), the spindle (131) is mounted on the base (111);
the base (111) has one or more threaded holes (31) on the bottom (1111) of the base (111) for one or more screws (4) to pass through so as to mount the fast-connecting safety tensioning device onto an object to be fixed in place.

2. The device of claim 1, wherein one or more rivet nuts each having one threaded hole (31) are integrally formed on the bottom (1111) of the base (111).

3. The device of claim 1, wherein the number of the threaded holes (31) is two and the two threaded holes (31) are respectively located on opposite sides of the spindle (131).

4. The device of claim 2, wherein two blind rivet nuts (3) each having one threaded hole (31) are disposed on the bottom (1111) of the base (111).

5. The device of claim 3, wherein a first threaded nut (3a) with a first threaded hole (31a) and a second threaded nut (3b) with a second threaded hole (31b) are disposed on the bottom (1111) of the base (111);
the first threaded nut (3a) is adjacent to the band (2) and extends downward from the bottom (1111) of the base (111), the second threaded nut (3b) extends upward from the bottom (1111) of the base (111).

6. The device of claim 1, wherein the one or more threaded holes (31) comprise a first threaded hole (31a) and a second threaded hole (31b);
a first column (3a′) with the first threaded hole (31a) extends downward from the bottom (1111) of the base (111), and a second column (3b′) with the second threaded hole (31b′) extends upward from the bottom (1111) of the base (111).

7. The device of claim 1, wherein a connecting plate (5) having one or more connecting holes (51′) for allowing the one or more screws (4) to pass through is disposed under the bottom (1111) of the base (111), so that the main body (1) is mounted onto an object to be fixed in place.
